(19) United States
(12) Patent Application Publication
(10) Pub. No.: US 2024/0222657 A1
(43) Pub. Date: Jul. 4, 2024

(54) FULL CELL MANIFOLD GASKET

(71) Applicant: TERRALIX CO., LTD., Buan-gun (KR)

(72) Inventors: Sang Cheol BAEK, Jeonju-si (KR); Dae Sung KIM, Buan-gun (KR)

(21) Appl. No.: 17/924,972

(22) PCT Filed: Jul. 18, 2022
(86) PCT No.: PCT/KR2022/010448

§ 371 Date: Nov. 11, 2022

(30) Foreign Application Priority Data
Nov. 19, 2021 (KR) 10-2021-0160232

(51) Int. Cl. H01M 8/0276; H01M 8/04537; H01M 8/10; H01M 8/2483

(52) U.S. Cl. CPC H01M 8/0276; H01M 8/04544; H01M 8/2483; H01M 2008/1095

(57) ABSTRACT

Proposed is a fuel cell manifold gasket. More particularly, proposed is a fuel cell manifold gasket, in which the gasket is composed of a support part of a hard conductive material and a compression part of an elastic material that covers each side of the support part, thereby preventing deformation of the gasket and preventing degradation of performance and durability due to deformation, and furthermore increasing manufacturing precision of the gasket and lowering the defect rate; and the support part of a conductive material is configured to make contact with a separator, thereby enabling stable voltage measurement and monitoring.

### TECHNICAL FIELD

The present disclosure relates generally to a fuel cell manifold gasket. More particularly, the present disclosure relates to a fuel cell manifold gasket, in which the gasket is composed of a support part of a hard conductive material and a compression part of an elastic material that covers each side of the support part, thereby preventing deformation of the gasket and preventing degradation of performance and durability due to deformation, and furthermore increasing manufacturing precision of the gasket and lowering the defect rate; and the support part of a conductive material is configured to make contact with a separator, thereby enabling stable voltage measurement and monitoring.

### BACKGROUND ART

A fuel cell is a type of power generator that converts chemical energy of fuel into electric energy through an electrochemical reaction. Fuel cells have a wide range of applications, including serving as industrial power generators, serving as household power generators, powering vehicles, and powering small electronic devices such as portable devices.

There are several types of fuel cells, but polymer electrolyte membrane fuel cells (PEMFCs) with high power density as disclosed in the following patent document are mainly used. In a PEMFC, a membrane electrode assembly (MEA) is located at the innermost portion of the cell. The MEA includes a polymer electrolyte membrane (PEM) for allowing transport of positively charged hydrogen ions (protons) therethrough, and catalyst layers, i.e., a cathode and an anode, applied on opposite surfaces of the PEM to cause hydrogen and oxygen to react. Hydrogen is supplied to the anode while air is supplied to the cathode, and electricity is generated through the reaction between oxygen contained in the air and hydrogen.

A separator of a conductive material is fastened to each end of the MEA to form a cell structure. Due to low voltage and low practicality of a single unit cell, several to hundreds of unit cells are generally stacked to form a stack.

At this time, as disclosed in the following patent document, a gasket is provided between adjacent unit cells to support adjacent separators and to form an airtight structure for the fuel cell, and a manifold is formed at each end of each of the unit cells to supply hydrogen, air, etc. into the unit cell.

However, a conventional gasket 100 is generally made of a material with low hardness such as silicon or ethylene propylene diene monomer (EPDM), so as illustrated in FIG. 1 (a), it is likely to be deformed when compressed during fastening of the stack. This causes unbalanced stress distribution, leading to damage to airtight seals and breakage of the separators.

In addition, as illustrated in FIG. 1 (b), the thickness of the gasket is constant under the normal condition. However, the degree of compression of the gasket is varied according to the use of the fuel cell, so each unit cell is not uniformly pressed. This causes a difference in contact resistance and mass transfer resistance between parts inside the unit cell, resulting in degradation of performance and durability due to non-uniformity of water discharge, electrical resistance, and heat transfer.

In addition, in a fuel cell stack using a plurality of unit cells stacked, it is essential to measure and monitor the voltage of each unit cell in order to monitor the operating state, performance, and error. The measuring of the cell voltage is achieved by contacting a conductor with a side surface of each unit cell.

Therefore, a side surface of a metal separator generally makes contact with the conductor during voltage measurement. However, due to the recent trend toward the reduction in thickness of the metal separator, the separator is difficult to make contact with the conductor and is likely to be deformed, thereby making it difficult to form a reliable voltage measurement structure.

(Patent Document) Korean Patent No. 10-0766155 (registered on Oct. 4, 2017) “Structure of gasket which prevents contamination of fuel cell stack”

### DISCLOSURE

### Technical Problem

Accordingly, the present disclosure has been made keeping in mind the above problems occurring in the related art.

An objective of the present disclosure is to provide a fuel cell manifold gasket, in which the gasket is composed of a support part of a hard conductive material and a compression part of an elastic material that covers each side of the support part, thereby preventing deformation of the gasket and preventing degradation of performance and durability due to deformation, and furthermore increasing manufacturing precision of the gasket and lowering the defect rate.

Another objective of the present disclosure is to provide a fuel cell manifold gasket, in which a support part of a conductive material is configured to make contact with a separator, thereby enabling stable voltage measurement and monitoring.

Still another objective of the present disclosure is to provide a fuel cell manifold gasket, in which an end of a support part is configured in various shapes and configured to make contact with a separator, thereby enabling the support part to make contact with the separator according to the shape and design conditions of the separator.

Yet another objective of the present disclosure is to provide a fuel cell manifold gasket, in which an outer end of a support part is configured in a concave or convex shape, thereby enabling easy and stable contact of a voltage measuring circuit.

### Technical Solution

The present disclosure is implemented by embodiments having the following configuration in order to achieve the above objectives.

According to one embodiment of the present disclosure, there is provided a fuel cell manifold gasket that is inserted between adjacent separators to support the separators and forms a manifold, the gasket including: a support part made of a hard conductive material of a predetermined thickness; and a compression part formed at each of opposite sides of the support part and made of a material having elasticity.

According to another embodiment of the present disclosure, in the gasket according to the present disclosure, the support part may include a separator contact end protruding inwards and configured to make contact with the separators.

According to still another embodiment of the present disclosure, in the gasket according to the present disclosure, the separator contact end may be bent downwards so as to make contact with a separator located under the gasket.

According to yet another embodiment of the present disclosure, in the gasket according to the present disclosure, the separator contact end may include a pair of elastic separated ends spread in upper and lower directions, made of a material having elasticity, and configured to make contact with the separators located at upper and lower positions.

According to still yet another embodiment of the present disclosure, in the gasket according to the present disclosure, the support part may further include a measuring contact end formed on an opposite side of the separator contact end and configured to make contact with a circuit for measuring voltage, and the measuring contact end may include any one of a concave end recessed inwards and a convex end protruding outwards.

### Advantageous Effects

The present disclosure can achieve the following effects by the above embodiments, and the configuration, combination, and use relationship described below.

A fuel cell manifold gasket according to the present disclosure is composed of a support part of a hard conductive material and a compression part of an elastic material that covers each side of the support part, thereby preventing deformation of the gasket and preventing degradation of performance and durability due to deformation, and furthermore increasing manufacturing precision of the gasket and lowering the defect rate.

The support part of a conductive material is configured to make contact with a separator, thereby enabling stable voltage measurement and monitoring.

An end of the support part is configured in various shapes and configured to make contact with the separator, thereby enabling the support part to make contact with the separator according to the shape and design conditions of the separator.

An outer end of the support part is configured in a concave or convex shape, thereby enabling easy and stable contact of a voltage measuring circuit.

### DESCRIPTION OF DRAWINGS

FIG. 1 is a reference view illustrating a deformed state of a conventional gasket.

FIG. 2 is a reference view illustrating a deformed state of a manifold hole of the conventional gasket.

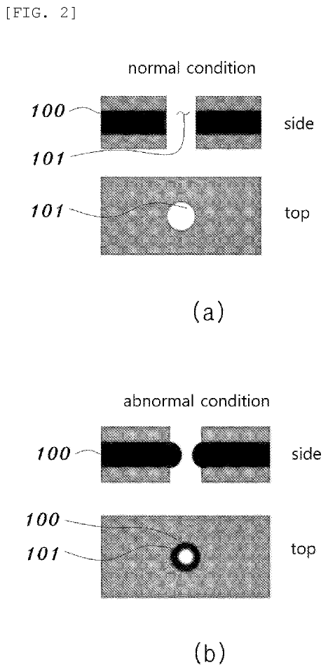

FIG. 3 is a sectional view illustrating a fuel cell manifold gasket according to an embodiment of the present disclosure.

FIG. 4 is a sectional view illustrating a fuel cell manifold gasket according to another embodiment of the present disclosure.

FIG. 5 is a sectional view illustrating a fuel cell manifold gasket according to still another embodiment of the present disclosure.

FIG. 6 is a sectional view illustrating a measuring contact end of the fuel cell manifold gasket according to the present disclosure.

FIG. 7 is an image illustrating an actual manufacturing example of the fuel cell manifold gasket according to the embodiment of the present disclosure.

### DESCRIPTION OF THE REFERENCE NUMERALS IN THE DRAWINGS

1: support part 11: separator contact end
111: bent end 113: elastic separated end
13: measuring contact end 131: concave end
133: convex end 3: compression part
B: separator B1: cathode separator
B11: protruding portion B13: flat portion
B3: anode separator
100: gasket 101: flow path
200: separator

### BEST MODE

Hereinafter, exemplary embodiments of a fuel cell manifold gasket according to the present disclosure will be described in detail with reference to the accompanying drawings. In the following description of the present disclosure, detailed descriptions of known functions and components incorporated herein will be omitted when it may make the subject matter of the present disclosure unclear. Unless the context clearly indicates otherwise, it will be further understood that the terms “comprise”, “include”, and/or “have”, when used herein, specify the presence of stated features, integers, steps, operations, elements, and/or components, but do not preclude the presence or addition of one or more other features, integers, steps, operations, elements, components, and/or groups thereof.

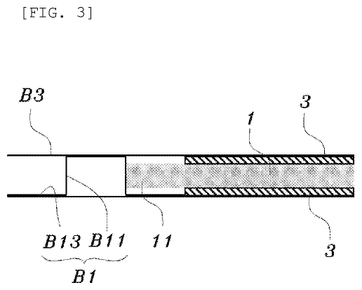

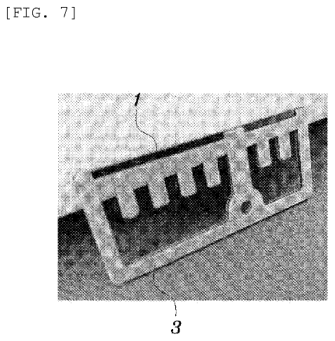

A fuel cell manifold gasket according to an embodiment of the present disclosure will be described with reference to FIGS. 3 to 7. The fuel cell manifold gasket includes a support part 1 made of a hard conductive material having a predetermined thickness, and a compression part 3 formed at each of opposite sides of the support part 1 and made of a material having elasticity.

The fuel cell manifold gasket according to the present disclosure is a configuration inserted between adjacent separators B to support the separators B. The gasket is inserted between an anode separator B3, which forms a passage through which hydrogen is supplied to an anode, and a cathode separator B1, which forms a passage through which air is supplied to a cathode and a cooling channel, and forms a manifold having a predetermined space at each of opposite ends of the separator B to form a passage through which hydrogen, air, etc. are supplied to each unit cell of a fuel cell.

In particular, the fuel cell manifold gasket is manufactured by inserting the support part 1 of a hard material between the soft materials, unlike a conventional gasket made of a soft material, thereby preventing deformation of the gasket and maintaining a constant distance between the separators B. Thus, it is possible to prevent damage to airtight seals or breakage due to deformation of the gasket, and to prevent degradation of performance and durability due to non-uniformity of water discharge, electrical resistance, heat transfer, etc. in a stack.

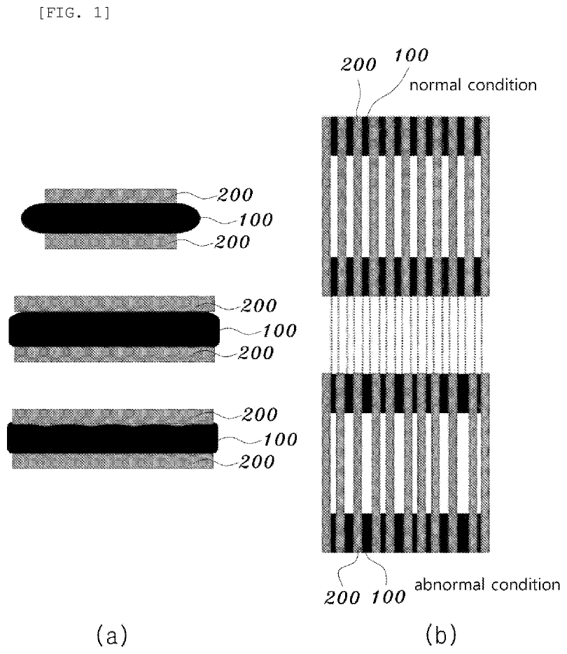

In addition, as illustrated in FIG. 1, the conventional gasket made of a soft material was problematic in that deformation thereof caused a change in size of a flow path 101 through which air or hydrogen is supplied, resulting in non-uniformity of the flow rate. However, in the present disclosure, by forming the support part 1, it is possible to minimize deformation of the gasket and maintain a uniform flow rate.

Also, another problem of the conventional gasket made of a soft material was that it was manufactured in the form of a thin sheet, so the defect rate was high and the yield was low. However, in the present disclosure, by adding the support part 1 of a hard material, it is possible to increase manufacturing precision of the gasket and lower the defect rate.

The support part 1 is a configuration made of a hard conductive material of a predetermined thickness, and is integrally coupled to the respective compression parts 3 between the compression parts 3. The support part 1 is made of a hard material to support the compression parts 3 so as to prevent deformation and increase the manufacturing yield as described above, and in particular is made of a conductive material, such as a metal or a conductive plastic, to measure the voltage of the fuel cell. In other words, in the fuel cell, it is essential to measure the voltage of each unit cell in order to monitor the operating state, performance, error, etc., but a reduced thickness of the separators B made it very difficult to measure the voltage in connection with the separators B. To solve this problem, in the present disclosure, the support part 1 is configured to be made of a conductive material and to make contact with the separators B, thereby enabling the voltage of the separators B to be measured through the support part 1. To this end, the support part 1 has, at a first side thereof, a separator contact end 11 making contact with the separators B, and, at a second side thereof, a measuring contact end 13 connected to a circuit for measuring voltage.

The separator contact end 11 is a configuration formed at a first end of the support part 1 to make contact with the separators B, and as illustrated in FIG. 3, is formed to protrude toward the separators B to make contact therewith. The separators B of the fuel cell include the cathode separator B1 provided at the cathode and the anode separator B3 provided at the anode. The cathode separator B1 includes a plurality of protruding portions B11 formed at a regular interval in a convex shape, and a flat portion B13 connecting the protruding portions B11. Air for cooling and air for reaction respectively flow through opposite spaces formed by the protruding portions B11 and the flat portion B13. At this time, as illustrated in FIG. 3, the separator contact end 11 may be formed to make contact with a side surface of a protruding portion B11 of the cathode separator B1 so that the current of the separators B flows through the support part 1.

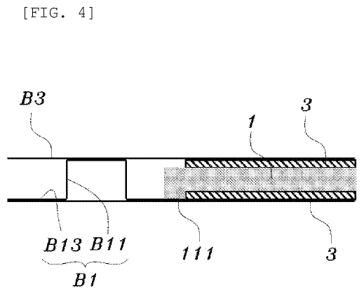

In addition, as illustrated in FIG. 4, the separator contact end 11 may be formed to have a bent end 111 bent downwards to make contact with the flat portion B13 of the cathode separator B1. In this case, the support part 1 is pressed by stacked unit cells, so that the contact between the separator contact end 11 and the cathode separator B1 is more stably maintained.

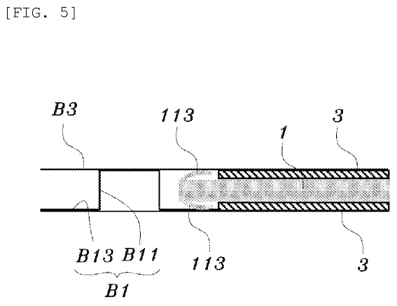

In addition, as illustrated in FIG. 5, the separator contact end 11 may include a pair of elastic separated ends 113 spread in upper and lower directions and made of a material having elasticity. As the elastic separated ends 113 are pressed, they are brought into contact with the anode separator B3 and the flat portion B13 of the cathode separator B1. In this case, the formation of the separator contact end 11 is somewhat more complicated than in the embodiments of FIGS. 3 and 4, but the separator contact end 11 makes contact with the anode separator B3 and the cathode separator B1 by the elasticity of the elastic separated ends 113 to maintain a more stable contact state.

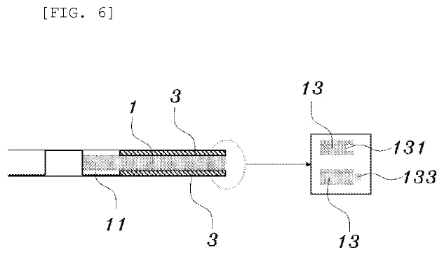

The measuring contact end 13 is a configuration formed on the opposite side of the separator contact end 11 and connected to the circuit for measuring voltage. In order to ensure stable and easy contact, as illustrated in FIG. 6, the measuring contact end 13 has a concave end 131 recessed inwards or a convex end 133 protruding outwards. Thus, the voltage is measured by easily contacting the circuit to the concave end 131 or the convex end 133 in response to the shape of a circuit contact portion of the measuring contact end 13, and the measuring contact end 13 is maintained in a stable contact state during the measurement.

The compression parts 3 are a configuration formed at the opposite sides of the support part 1, and are made of a soft material having elasticity, such as silicone or ethylene propylene diene monomer (EPDM). Therefore, the compression parts 3 allow the entire gasket to have elasticity while interposing the support part 1 of a hard material of a predetermined thickness therebetween, thereby preventing deformation of the gasket and increasing the manufacturing yield.

Although applicant has described applicant's preferred embodiments of this disclosure, it should be understood that these embodiments are not construed as limited to the disclosure and should be understood to include all changes, equivalents, and alternatives within the idea and the technical scope of the disclosure.

1. A fuel cell manifold gasket that is inserted between adjacent separators to support the separators and forms a manifold, the gasket comprising:
a support part made of a hard conductive material of a predetermined thickness; and
a compression part formed at each of opposite sides of the support part and made of a material having elasticity.

2. The gasket of claim 1, wherein the support part comprises a separator contact end protruding inwards and configured to make contact with the separators.

3. The gasket of claim 2, wherein the separator contact end is bent downwards so as to make contact with a separator located under the gasket.

4. The gasket of claim 2, wherein the separator contact end comprises a pair of elastic separated ends spread in upper and lower directions, made of a material having elasticity, and configured to make contact with the separators located at upper and lower positions.

5. The gasket of claim 2, wherein the support part further comprises a measuring contact end formed on an opposite side of the separator contact end and configured to make contact with a circuit for measuring voltage, and
the measuring contact end comprises any one of a concave end recessed inwards and a convex end protruding outwards.
